(19) United States
(12) Patent Application Publication
(10) Pub. No.: US 2023/0114263 A1
(43) Pub. Date: Apr. 13, 2023

(54) HARDWARE ASSISTED EFFICIENT MEMORY MANAGEMENT FOR DISTRIBUTED APPLICATIONS WITH REMOTE MEMORY ACCESSES

(71) Applicant: Intel Corporation, Santa Clara, CA (US)

(72) Inventors: Ren Wang, Portland, OR (US); Poonam Shidlyali, Bengaluru (IN); Tsung-Yuan Tai, Portland, OR (US)

(21) Appl. No.: 18/065,241

(22) Filed: Dec. 13, 2022

(51) Int. Cl. G06F 9/50; G06F 9/48; G06F 9/30

(52) U.S. Cl. CPC G06F 9/5016; G06F 9/4812; G06F 9/3009

(57) ABSTRACT

Systems, apparatuses and methods may provide for technology that uses centralized hardware to detect a local allocation request associated with a local thread, detect a remote allocation request associated with a remote thread, wherein the remote allocation request bypasses a remote operating system, and process the local allocation request and the remote allocation request with respect to central heap, wherein the central heap is shared by the local thread and the remote thread. The local allocation request and the remote allocation request may include one or more of a first request to allocate a memory block of a specified size, a second request to allocate multiple memory blocks of a same size, a third request to resize a previously allocated memory block, or a fourth request to deallocate the previously allocated memory block.

### TECHNICAL FIELD

Embodiments generally relate to memory management. More particularly, embodiments relate to hardware assisted efficient memory management for distributed applications with remote memory accesses.

### BACKGROUND

With recent developments in microservices and distributed cloud workloads, distributed applications accessing memory remotely has become more prevalent. Conventional remote memory management solutions, however, may result in contentions between application threads and/or inefficient use of general purpose central processing unit (CPU, e.g., host processor) resources.

### BRIEF DESCRIPTION OF THE DRAWINGS

The various advantages of the embodiments will become apparent to one skilled in the art by reading the following specification and appended claims, and by referencing the following drawings, in which:

FIG. 1 is a block diagram of an example of a memory layout for a software memory allocator;

FIG. 2 is a block diagram of an example of a set of linked lists for small object allocations in a software memory allocator;

FIG. 3 is a block diagram of an example of a set of linked lists for medium object allocations in a software memory allocator;

FIG. 4 is a block diagram of an example of memory management allocation paths for a software memory allocator;

FIG. 5 is a block diagram of an example of a computing system having a memory management subsystem to handle local allocation requests according to an embodiment;

FIG. 6 is a block diagram of an example of a computing system having a memory management subsystem to handle local and remote allocation requests according to an embodiment;

FIG. 7 is a signaling diagram of an example of remote allocation communications according to an embodiment;

FIG. 8 is a schematic diagram of an example of a memory management subsystem according to an embodiment;

FIG. 9 is a block diagram of an example of data streaming hardware having a memory management subsystem would fit into a computing architecture according to an embodiment;

FIG. 10 is a flowchart of an example of a method of operating a memory management subsystem according to an embodiment;

FIG. 11 is a flowchart of an example of a method of handling local and remote allocation requests according to an embodiment;

FIG. 12 is a flowchart of an example of a method of handling local allocation requests according to an embodiment;

FIG. 13 is a flowchart of an example of a method of handling remote allocation requests according to an embodiment;

FIG. 14 is a flowchart of an example of a method of learning memory profiles of applications according to an embodiment; and

FIG. 15 is an illustration of an example of a semiconductor package according to an embodiment.

### DESCRIPTION OF EMBODIMENTS

Modern memory allocation/deallocation is typically handled by software libraries that execute in user space and consume central processing unit (CPU) cycles during execution. Memory allocation accounts for a significant portion of total computing resource utilization (e.g., on the order of 10% in data centers). The technology described herein reduces the computing resource utilization associated with memory allocation/deallocation in cloud computing infrastructures.

Conventional memory allocators may “bin” memory and keep track of which parts of memory are in use and which parts are free. For example, an allocator might organize available chunks of memory into bins, wherein the bins are classified by size. There may also be different categories of memory chunks (e.g., small, large, “huge”, etc.). These chunks of memory are typically obtained from an operating system (OS) by calling a memory map system call (e.g., mmap). The system call may also include metadata that identifies the size and status (e.g., in use or not in use) of the chunk. Some allocators support explicit or implicit garbage collection (e.g., deallocation of memory allocated to objects not in use). The efficiency of allocators may further be defined based on how well the allocators deal with fragmentation (e.g., both internal and external). Overall, the memory consumption of an allocator and total response time for each request impacts the overhead of the allocator from a user application perspective.

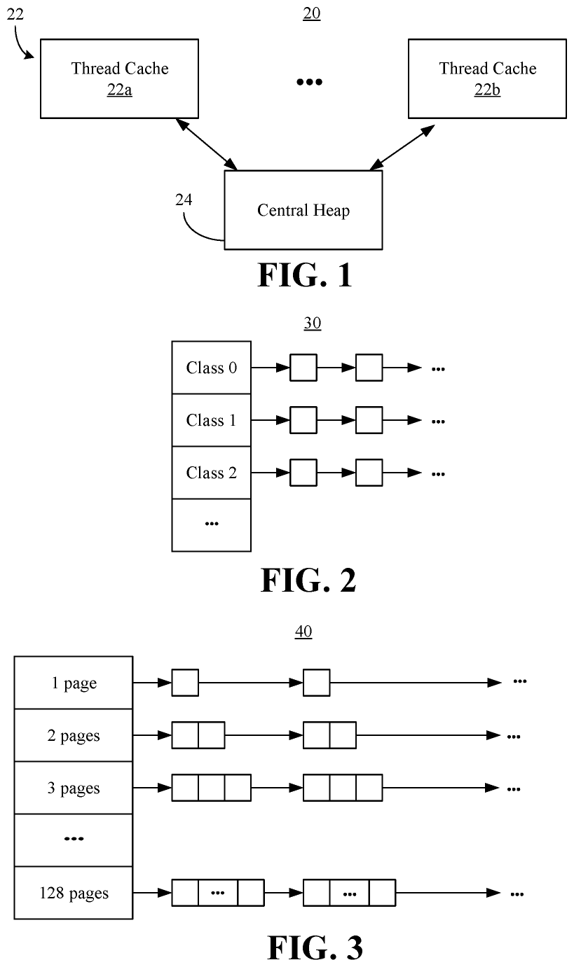

Turning now to FIG. 1, a memory layout 20 is shown for a plurality of application threads in a multi-core architecture, wherein each thread is assigned a local thread cache 22 (22a, 22b) by a memory allocator (e.g., “tcmalloc”) on a per core basis. Relatively small allocations are satisfied from the local thread caches 22. Objects are moved from a central heap 24 (e.g., shared data structure) into the local thread caches 22 as needed, and periodic garbage collections are used to migrate memory back from the local thread cache 22 into the central heap 24. As will be discussed in greater detail, singly linked lists of free objects may be maintained for the local thread caches 22 on a per size-class basis.

FIG. 2 shows a set of linked lists 30 for free small object allocations in the local thread caches 22 (FIG. 1). When allocating a small object, the size of the object is mapped to the corresponding size-class and the corresponding linked list is searched in the thread cache for the current thread. If the free list is not empty, the first object is removed from the list and returned. When following this fast path, the memory allocator accesses the local thread cache and acquires no locks. When the local thread cache cannot satisfy the request, the allocator transitions to a central heap such as, for example, the central heap 24 (FIG. 1), wherein the central heap is shared by multiple threads. As will be discussed in greater detail, embodiments provide for a centralized hardware solution that eliminates contention between threads when allocation requests are processed with respect to the central heap. In one example, a medium object size (e.g., 256K≤size≤1 MB) is rounded up to a page size (8K) and is handled by the central heap.

FIG. 3 shows a set of free lists 40 that may be used for objects of medium size. In the illustrated example, the central heap includes the set of free lists 40. An allocation for k pages is satisfied by looking in the k^{th} free list. If that free list is empty, the next free list is searched, and so forth. If no medium-object free list can satisfy the allocation, then the allocation is treated as a large object allocation.

For large object allocations, spans of free memory that can satisfy the allocations may be tracked in a “red-black” tree (e.g., self-balancing binary search tree in which each node stores an extra bit representing “color” such as “red” or “black”), sorted by size. The color representations may therefore ensure that the tree remains balanced during insertions and deletions. Allocations follow the best-fit algorithm: the tree is searched to find the smallest span of free space that is larger than the requested allocation. The allocation is carved out of that span, and the remaining space is reinserted either into the large object tree or possibly into one of the smaller free-lists as appropriate. If no span of free memory is located that can fit the requested allocation, memory is fetched from the system (e.g., via a memory management system call).

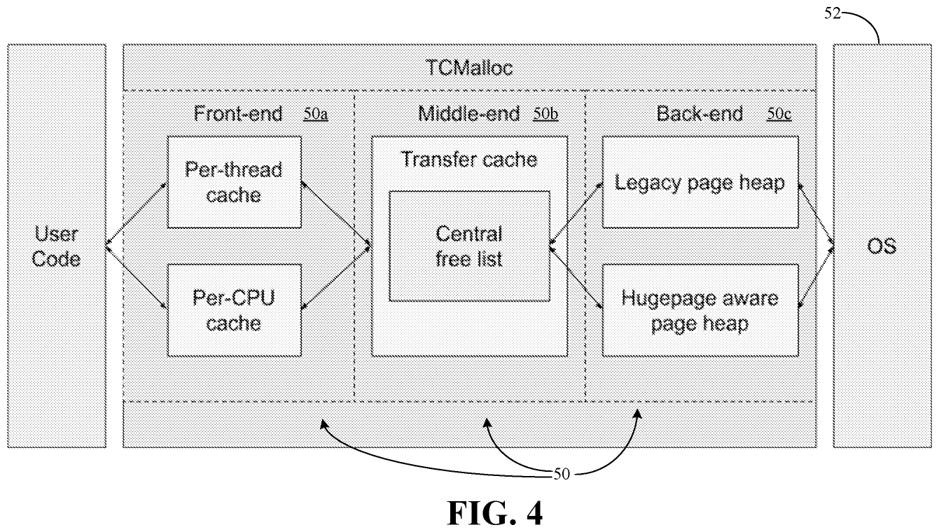

FIG. 4 shows a set of memory management allocation paths 50 (50a-50c) for a huge-page aware memory allocator (e.g., tcmalloc). In the illustrated example, a first path 50a (e.g., fast path, front-end) uses per-thread caches, a second path 50b (e.g., slow path, middle-end) uses a transfer cache (e.g., central heap) in hardware, and a third path 50c (e.g., extra slow path, back-end) is used to expand or contract the central heap via an OS 52. The second path 50b and the third path 50c path may incur substantial overhead due to contentions when there are many threads requesting large memory allocations (e.g., which exceeds the per thread cache). As will be discussed in greater detail, the technology described herein optimizes the second path 50b and the third path 50c to eliminate contentions and improve performance. More particularly, embodiments offload memory management tasks to a hardware component that accelerates such tasks.

For example, the technology described herein includes a hardware assisted approach to handle local and remote memory management. The hardware entity is a memory management subsystem (e.g., local remote memory manager/LRMM) that can receive requests from both local cores and remote clients via an input/output (IO) interface (e.g., network interface card/NIC) and perform memory management tasks accordingly. In one example, no changes are needed in existing software applications since the interaction with the hardware can be hidden in appropriate allocator libraries. Remote clients invoke remote direct memory access (RDMA) primitives for remote memory requests, which are relayed to the memory management subsystem. Management of memory bins of the allocators is also handled in the memory management subsystem.

As an exemplary implementation, data streaming hardware is augmented to support the memory management subsystem. In this regard, an additional category of operations called “memory management” may be introduced to the existing operations of the data streaming hardware. The new operation category supports four types of memory management related operations—“alloc”, “free”, “realloc”, and “calloc”. Alloc (e.g., allocation) is used to allocate a block of a requested size. Calloc (e.g., contiguous allocation) is used to allocate multiple blocks of memory having the same size (e.g., useful for complex data structures such as arrays and structures). Realloc (e.g., reallocation) is used to resize a memory block that has previously been allocated by alloc or calloc. Free is used to deallocate memory previously allocated by alloc, realloc or calloc. Embodiments enhance engines currently present in data streaming hardware to support these new operations. Although data streaming hardware is used as an example for the purposes of discussion, the technology described herein can exist as separate hardware or be co-located with other existing hardware that shares similar interfaces with data streaming hardware.

Embodiments therefore require no changes in applications (e.g., only allocator libraries are modified based on availability of the LRMM on the platform). Additionally, the CPU is no longer involved as the details of allocation/deallocations are handled by the LRMM. Accordingly, the CPU has more availability to perform useful user applications. Moreover, multi-thread locking contention from cores is resolved (e.g., “spin locks” are eliminated) as the memory management is handled by a single hardware entity. This approach provides applications with deterministic performance. For the distributed case, applications on the client-side are free of deallocation policies or the responsibility of sending an additional remote procedure call (RPC) request to the server to indicate which buffers can be freed.

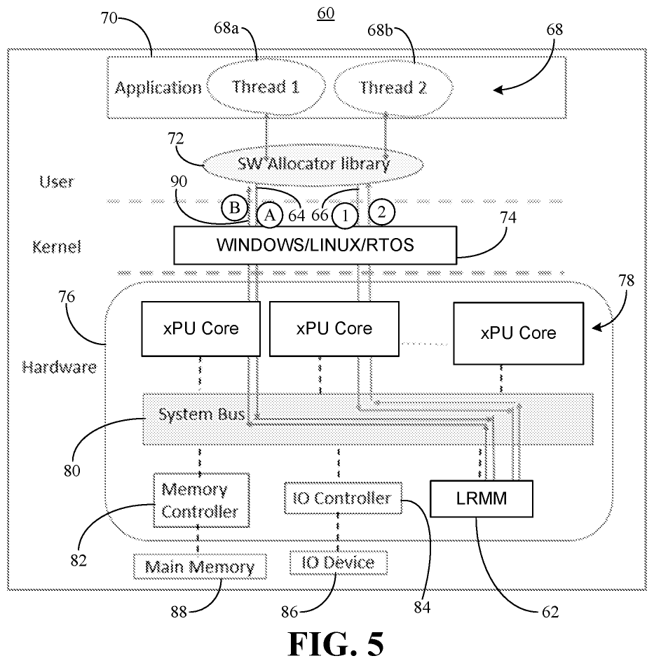

FIG. 5 shows a computing system 60 (e.g., server, platform system architecture) having a memory management subsystem 62 (e.g., LRMM) to handle local allocation requests 64, 66 from a plurality of threads 68 (68a, 68b) in an application 70 (e.g., microservice, distributed cloud workload). In the illustrated example, the threads 68 are linked with a software (SW) based allocator library 72 at a top layer, and an OS kernel 74 (e.g., WINDOWS, LINUX, embedded/RTOS) beneath the allocator library 72. Additionally, a hardware layer 76 includes xPU cores 78 (e.g., CPU, graphics processing unit/GPU, infrastructure processing unit/IPU, etc.), a system bus 80, a memory controller 82, an input/output (IO) controller 84, and the memory management subsystem 62. As integrated hardware within the hardware layer 76, the memory management subsystem 62 directly connects with the system bus 80, which has access to the xPU cores 78, an IO device 86 (e.g., network interface card/NIC) and system memory 88 (e.g., main memory).

In an embodiment, the threads 68 of the application 70 run on different cores and are supported by various OS's. All threads 68 of the application 70 can communicate with the memory management subsystem 62 via the software-based allocator library 72. Fast-path allocations via the thread caches occur in the library 72 (e.g., in user-space itself). When a thread cache is exhausted, the library 72 issues the local allocation requests 64, 66 to the memory management subsystem 62.

Meanwhile, remote applications (not shown) running on client systems (not shown) access memory via the IO device 86. When appropriate, the IO device 86 issues memory management related requests to the memory management subsystem 62 via the system bus 80, as will be discussed in greater detail.

For the case when multiple xPU cores 78 and/or IO devices 86 make simultaneous requests, the memory management subsystem 62 can queue and service all requests, without conducting inefficient locking/concurrency control processes. The centralized and hardware-based nature of the memory management subsystem 62 provides the application 70 with deterministic behavior, which is particularly advantageous for modern data centers. Meanwhile, the memory management subsystem 62 can employ intelligent schemes such as keeping track of memory allocated but not used for certain periods, which helps with dealing with defragmentation efficiently.

More particularly, the application 70 can communicate via the software-based allocator library 72 and existing malloc/alloc APIs as supported by the library. Alternatively, the application 70 can be modified to interact with memory management subsystem 62 directly.

In one example, the memory management subsystem 62 maintains the memory bins, accesses the thread cache, and maintains the central heap and page heap in the process heap space. The memory management subsystem 62 may also keep track of the allocation requests 64, 66 and mark the lists that are later used for garbage collection.

More particularly, when a first thread 68a issues the memory allocation request 64, the first thread 68a calls an application programming interface (API) supported by the software-based allocator library 72. The library 72 first checks the local thread cache corresponding to the first thread 68a, and if the request 64 can be satisfied with the thread cache, bins in the thread cache are allocated and the first thread 68a continues. If the request 64 cannot be satisfied from the thread cache, the library 72 assembles the request 64 into a descriptor that describes the request (e.g., requested memory size) and sends the descriptor to the memory management subsystem 62 using, for example, hardware interfacing architecture instructions.

The memory management subsystem 62 may then parse the request 64 and check the central heap to determine whether the central heap can satisfy the request. If not, the memory management subsystem 62 reaches out the page heap to allocate the requested memory.

In one example, the memory management subsystem 62 sends a response 90 by writing an allocated memory pointer to a completion record, and issuing an interrupt. The interrupt may be bypassed if the library 72 is running in polling mode. The library 72 then checks the completion record, obtains the memory, and responds to the application 70.

In an embodiment, the memory management subsystem 62 proactively monitors the page heap for exhaustion. If the page heap needs to be enlarged or diminished, an out-out-band (OOB) message may be sent to the OS (e.g., enabling synchronization with OS managed memory). If the page heap is diminished, garbage collection may also be triggered. In the case of realloc/calloc, the memory management subsystem 62 copies the old buffer or writes a pattern to the system memory 88 via the memory controller 82.

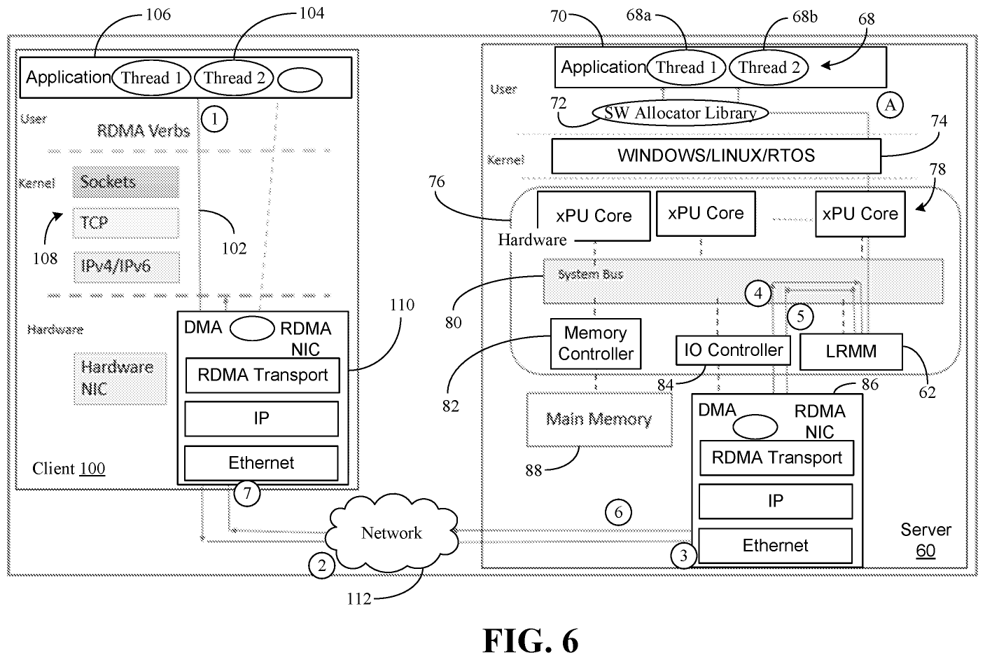

FIG. 6 shows the computing system 60, wherein the memory management subsystem 62 handles a remote allocation request 102 originating from a thread 104 of an application 106 (e.g., microservice, distributed cloud workload) executing on a client system 100. The application 70 and allocator library 72 in user space on the server-side operate similarly as described with respect to the local allocation requests 64, 66 (FIG. 5). Thus, the kernel 74 layer can be of any type of OS, the hardware layer 76 includes xPU cores 78, and the system bus 80 connects the xPU cores 78 to the memory controller 82, the IO device 86 and the memory management subsystem 62 (e.g., LRMM). In the illustrated example, the IO device 86 includes an RDMA NIC that can host limited thread caches and interact with the memory management subsystem 62. On the client side, the application 106 in user space is RDMA based using primitives for alloc/free. Accordingly, the remote allocation request 102 from the thread 104 by-passes an OS kernel 108 (e.g., including sockets, Transmission Control Protocol/TCP and/or Internet Protocol/IP layers) and goes directly to a remote IO device 110 (e.g., RDMA NIC), which forwards the remote allocation request 102 to the computing system 60 via a network 112 (e.g., lossy, lossless).

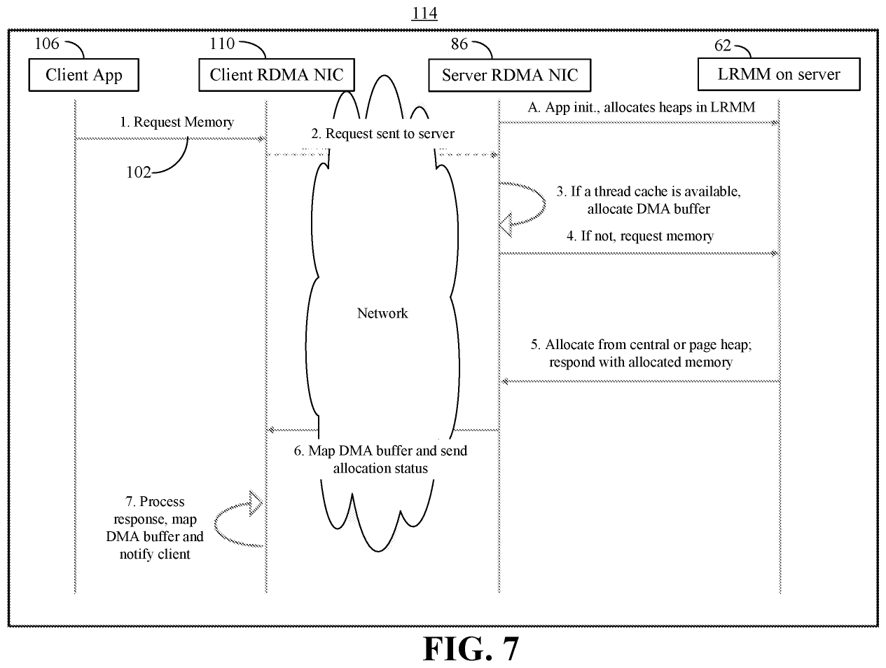

With continuing reference to FIGS. 6 and 7, a signaling diagram 114 for remote memory allocations is shown. In operation (A) central and page heaps are allocated in the memory management subsystem 62 during RDMA server application initialization. In operation (1), the client application 106 issues the remote allocation request 102 for memory using an RDMA primitive. In operation (2), the local IO device 86 receives and parses the request, wherein, if a thread cache in the local IO device 86 is available, the local IO device 86 allocates a DMA buffer in operation (3). Otherwise, the local IO device 86 assembles a descriptor and sends a memory management request to the memory management subsystem 62 in operation (4). As in the local case, the memory management subsystem 62 allocates the requested buffer for the client application 106 in operation (5), reaching out to the page heap if appropriate. If needed, an arbiter within the memory management subsystem 62 can give the remote allocation request 102 higher priority than local allocation requests due to, for example, latency in the network 112 and/or IO devices 86, 110. The memory management subsystem 62 then updates memory bin information and sends the assigned memory buffer pointer back to the local IO device 86. In operation (6), the local IO device 86 maps a DMA buffer and sends an allocation status update to the remote IO device 110. In operation (7), the remote IO device 110 notifies the client application 106 by sending a responsive message.

For a deallocation request, a similar flow is carried out and the local IO device 86 communicates with the memory management subsystem 62 to free up memory. The illustrated approach therefore eliminates the involvement of the OS kernel 108 (e.g., remote CPU) in handling remote requests. Indeed, the client system 100 does not incur any overhead for remote memory allocation/deallocation. The computing system 60 is therefore considered performance-enhanced at least to the extent that the memory management subsystem 62 reduces latency in the client application 106.

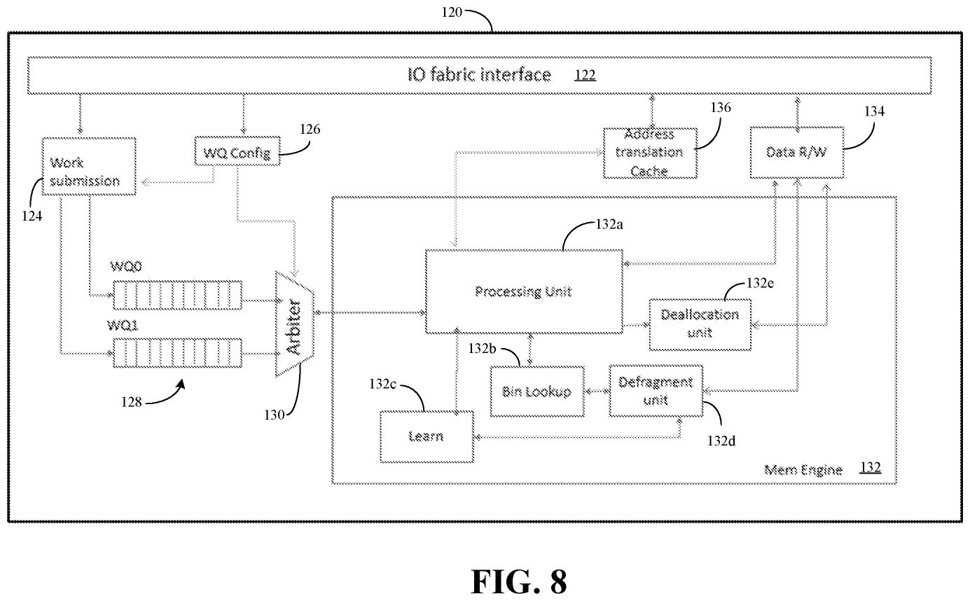

FIG. 8 shows a memory management subsystem 120 (e.g., LRMM) that may be readily substituted for the memory management subsystem 62 (FIGS. 6 and 7), already discussed. Various implementations can contain fewer blocks and potentially map to different physical arithmetic logic units (ALUs). Additionally, the memory management subsystem 120 may be implemented at least partly in configurable and/or fixed-functionality hardware. In the illustrated example, work requests that are memory management related operations from applications/NICs come in through an IO fabric interface 122 and are passed to a work submission unit 124, where the work requests are classified into separate queues based on user configuration. A work queue (WQ) configuration unit 126 is used to configure the work submission unit 124 and an arbiter 130 between a set of work queues 128. This configuration considers the nature of dynamic memory requests from various applications.

The arbiter 130 fetches requests from the WQs 128 and feeds the requests into a processing unit 132a of a memory engine 132 (132a-132e). The processing unit 132a reads operation codes (op codes) of the requests to determine the request type (e.g., alloc, free, realloc, calloc). Based on the request type, the processing unit 132a sends the requests to the appropriate component within the memory engine 132. The arbiter 130 can also implement quality of service (QoS) policies as appropriate and assign different WQs 128 different priorities. For example, due to the longer latency and higher retry expense of remote memory allocation requests, a higher priority could be assigned to requests from a NIC. The processing unit 132a is also responsible for sending out-of-band messages to the kernel.

Within the memory engine 132, a bin lookup unit 132b maintains a list of free and occupied memory bins. These bins are categorized based on size. Metadata containing the status of each bin may also be maintained in the bin lookup unit 132b. Additionally, a learn unit 132c keeps track of all requests, learns the memory profiles of applications using dynamic memory, and proactively allocates more bins when free bins fall short. In one example, a defragment unit 132d runs a defragmentation procedure and signals the bin lookup unit 132b to update status of bins. In an embodiment, a deallocation unit 132e takes in the free requests from the processing unit 132a and sends single requests to update the status in memory via a data read/write (R/W) interface 134. If the request type is “free”, then the bin lookup 132b is notified to update the status and then the deallocation unit 132e is notified. If the request type is “alloc”, then the bin lookup unit 132b is updated to change the bin status to “in use”.

After the memory management request is processed, the memory management subsystem 120 uses the data R/W interface 134 and an address translation cache 136 to write the results into a memory location predefined by the library (e.g., sent via the descriptor). In this regard, there are two ways to notify the library:

Interrupt mode. The memory management subsystem 120 raises an interrupt to the corresponding core as appropriate. The interrupt mode may be used when high performance is not required due to the interrupt overhead.

Polling mode. For applications that require relatively high performance, polling mode may be used. In this case, the library polls a flag in the predefined memory location. The memory management subsystem 120 updates the flag when the tasks are complete. When library detects the modified flag value, the library read the results (e.g., the pointer to the allocated memory) from a predefined location.

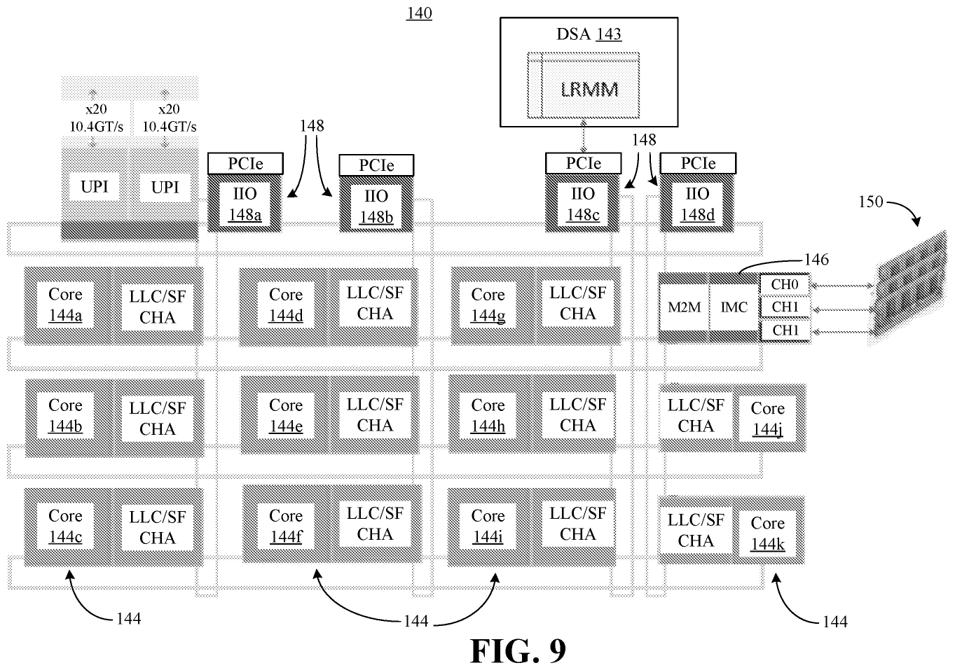

Turning now to FIG. 9, a computing architecture 140 (e.g., INTEL XEON) that supports communications with data streaming hardware 143 is shown. The illustrated data streaming hardware 143 includes a memory management subsystem 142 such as, for example, the memory management subsystem 62 (FIGS. 5-7) and/or the memory management subsystem 120 (FIG. 8), already discussed. In general, the data streaming hardware 143 can operate in CPU virtual address spaces, which may be required by memory management tasks. Additionally, the data streaming hardware 143 has work queues that can be used for memory management related requests. Moreover, the data streaming hardware 143 already defines software programming models that can be built on top of for hardware purposes. The memory management subsystem 142 may also co-exist with other hardware units if appropriate or implemented standalone hardware.

In the illustrated example, core units 144 (144a-144k) and uncore units (e.g., last level cache/LLC, switching fabric/SF) are connected with a memory controller 146 (e.g., integrated memory controller/IMC) and an integrated IO controller 148 (IIO, 148a-148d), on a mesh. The memory management subsystem 142 also sits on the same mesh and has access to each core 144, memory 150, and IO devices coupled to the IIOs 148 (e.g., via Peripheral Components Interconnect Express/PCIe).

The data streaming hardware 143 supports high performance data mover and transformation operations while freeing up CPU cycles. At a high level, the data streaming hardware 143 has work queues that take in work requests, engines for processing requests and allows configuration of how the work queues and engines are used. Clients may issue “alloc” requests in the form of an AIA descriptor in a work queue, which will be processed by the engines by checking whether the requested memory can be found in one of the existing bins. Engines will update the metadata and respond back to clients of allocation status. Similarly, when clients perform a “free” request, engines can mark the bins as unused. Based on a configurable parameter, fragmentation can be implemented. A default work request to compact memory takes care of both internal and external fragmentation. Indeed, these operations may be carried out in the background without affecting the execution of the CPU or client system. If the memory management engine is implemented differently, a similar API can also be implemented and used by the client.

For “realloc”, implementations may be similar to “alloc” and copies can be conducted by using existing architecture 140 operations such as “Mem Move”. For “calloc”, a combination of “alloc” and current data streaming hardware 143 “fill” may be used. Additionally, request queues being full is not an issue with the data streaming hardware 143 because the data streaming hardware 143 has relatively deep queues for incoming requests. Moreover, with AIA enqueue command instructions, when the queue is full, a bit will indicate whether the request was accepted, and QoS can be supported to serve threads with higher priority first. If the request is rejected, the sending agent will resubmit the request.

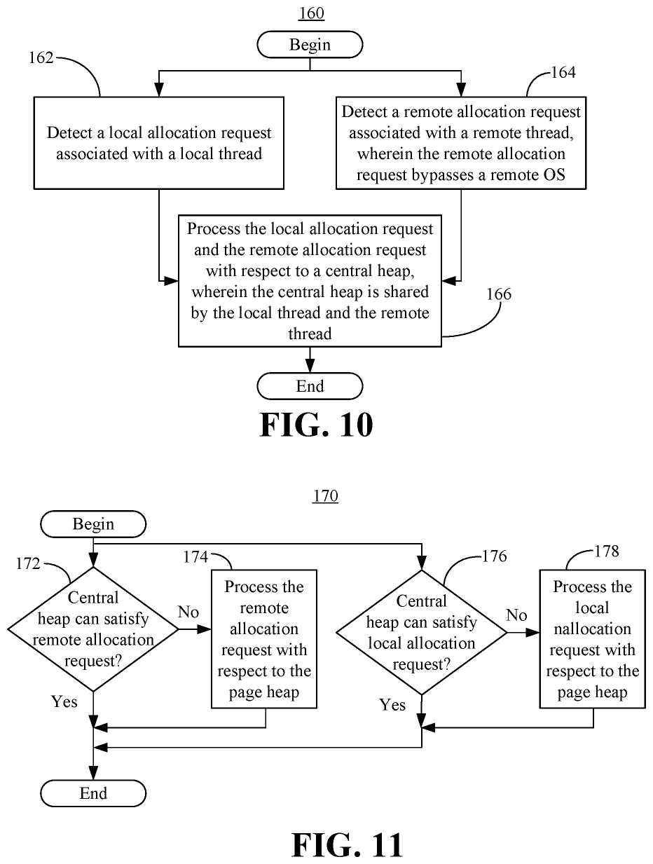

FIG. 10 shows a method 160 of operating a memory management subsystem. The method 160 may generally be implemented in a memory management subsystem such as, for example, the memory management subsystem 62 (FIGS. 5-7) and/or the memory management subsystem 120 (FIG. 8), already discussed. More particularly, the method 160 may be implemented in one or more modules as hardware. For example, hardware implementations may include configurable logic (e.g., configurable hardware), fixed-functionality logic (e.g., fixed-functionality hardware), or any combination thereof. Examples of configurable logic include suitably configured programmable logic arrays (PLAs), field programmable gate arrays (FPGAs), complex programmable logic devices (CPLDs), and general purpose microprocessors. Examples of fixed-functionality logic include suitably configured application specific integrated circuits (ASICs), combinational logic circuits, and sequential logic circuits. The configurable or fixed-functionality logic can be implemented with complementary metal oxide semiconductor (CMOS) logic circuits, transistor-transistor logic (TTL) logic circuits, or other circuits.

Illustrated processing block 162 provides for detecting (e.g., by a memory management subsystem that includes logic coupled to one or more substrates) a local allocation request associated with a local thread and block 164 detects (e.g., by the memory management subsystem) a remote allocation request associated with a remote thread, wherein the remote allocation request bypasses a remote OS. In one example, block 162 receives the local allocation request via an allocator library. Additionally, block 164 may receive the remote allocation request via an IO interface such as, for example, a NIC. The local allocation request and the remote allocation request may include one or more of a first request (e.g., alloc) to allocate a memory block of a specified size, a second request (e.g., calloc) to allocate multiple memory blocks of a same size, a third request (e.g., realloc) to resize a previously allocated memory block, or a fourth request (e.g., free) to deallocate the previously allocated memory block. Block 166 processes (e.g., by the memory management subsystem) the local allocation request and the remote allocation request with respect to a central heap, wherein the central heap is shared by the local thread and the remote thread. In an embodiment, block 166 includes prioritizing the remote allocation request over the local allocation request.

The method 160 therefore enhances performance at least to the extent that using a single hardware entity to process both remote allocation requests and local allocation requests with respect to a shared central heap resolves locking contention between threads and/or provides applications with deterministic performance. Additionally, bypassing the remote OS with the remote allocation request enables remote CPU hardware to handle more useful user applications. Indeed, the illustrated solution releases client-side applications from the responsibility for deallocation policies and/or the issuance of RPC requests to indicate that buffers can be freed.

FIG. 11 shows a method 170 of handling local and remote allocation requests. The method 170 may generally be incorporated into block 166 (FIG. 10), already discussed. More particularly, the method 170 may be implemented in one or more modules as hardware.

Illustrated processing block 172 provides for determining whether a central heap can satisfy a remote allocation request. If not, block 174 processes the remote allocation request with respect to a page heap. In an embodiment, block 174 involves communicating with a local OS to satisfy the remote allocation request. In parallel, block 176 determines whether the central heap can satisfy a local allocation request. If not, block 178 processes the local allocation request with respect to the page heap. In one example, block 178 involves communicating with the local OS to satisfy the local allocation request. Block 174 and/or block 178 may also include monitoring the page heap for an exhaustion condition and sending an out of band message to a local OS in response to the exhaustion condition.

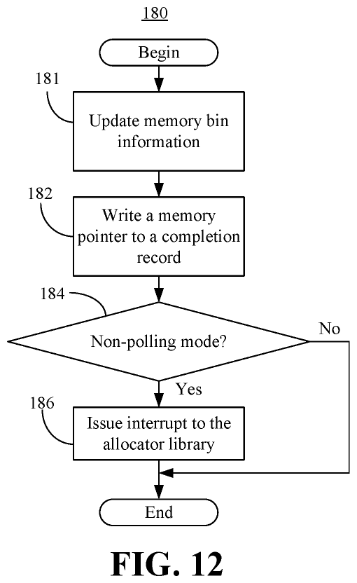

FIG. 12 shows a method 180 of handling local allocation requests. The method 180 may generally be incorporated into block 166 (FIG. 10), already discussed. More particularly, the method 180 may be implemented in one or more modules as hardware.

Illustrated processing block 181 updates memory bin information and block 182 writes a memory pointer to a completion record, wherein the memory pointer indicates a buffer associated with the memory allocation. In one example, block 184 determines whether the allocator library is operating in a non-polling mode. If so, block 186 issues an interrupt to the allocator library. Otherwise, the method 180 may bypass block 186 and terminate.

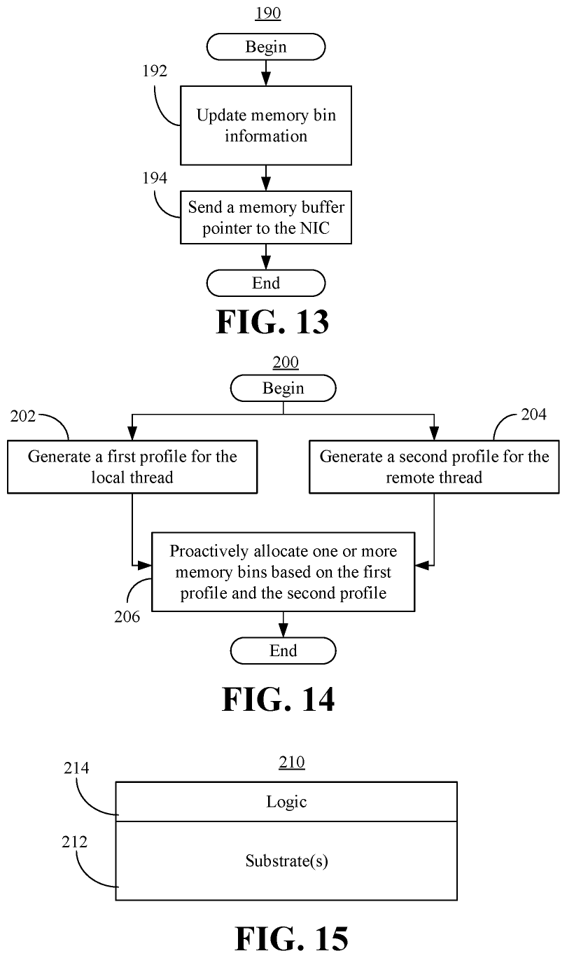

FIG. 13 shows a method 190 of handling remote allocation requests. The method 190 may generally be incorporated into block 166 (FIG. 10), already discussed. More particularly, the method 190 may be implemented in one or more modules as hardware.

Illustrated processing block 192 provides for updating memory bin information based on the memory allocation. Additionally, block 194 may send a memory buffer pointer to the IO device/NIC from which the remote allocation request was received.

FIG. 14 shows a method 200 of learning memory profiles of applications. The method 200 may generally be implemented in a memory management subsystem such as, for example, the memory management subsystem 62 (FIGS. 5-7) and/or the memory management subsystem 120 (FIG. 8), already discussed. More particularly, the method 200 may be implemented in one or more modules as hardware.

Illustrated processing block 202 generates a first profile for a local thread, wherein block 204 generates a second profile for a remote thread. Illustrated block 206 proactively allocates one or more memory bins based on the first profile and the second profile.

FIG. 15 shows a semiconductor apparatus 210 (e.g., chip, die) that includes one or more substrates 212 (e.g., silicon, sapphire, gallium arsenide) and logic 214 (e.g., transistor array and other integrated circuit/IC components) coupled to the substrate(s) 212. The semiconductor apparatus 210 can be readily substituted for the memory management subsystem 62 (FIGS. 5-7) and/or the memory management subsystem 120 (FIG. 8). The logic 214, which may be implemented at least partly in configurable and/or fixed-functionality hardware, may generally implement one or more aspects of the method 160 (FIG. 10), the method 170 (FIG. 11), the method 180 (FIG. 12), the method 190 (FIG. 13) and/or the method 200 (FIG. 14), already discussed. Thus, the logic 214 may detect a local allocation request associated with a local thread, detect a remote allocation request associated with a remote thread, wherein the remote allocation request bypasses a remote OS, and process the local allocation request and the remote allocation request with respect to a central heap, wherein the central heap is shared by the local thread and the remote thread.

In one example, the logic 214 includes transistor channel regions that are positioned (e.g., embedded) within the substrate(s) 212. Thus, the interface between the logic 214 and the substrate(s) 212 may not be an abrupt junction. The logic 214 may also be considered to include an epitaxial layer that is grown on an initial wafer of the substrate(s) 212.

### Additional Notes and Examples

Example 1 includes a performance-enhanced computing system comprising a plurality of processor cores, a system bus coupled to the plurality of processor cores, and a memory management subsystem coupled to the system bus, wherein the memory management subsystem includes logic coupled to one or more substrates, the logic to detect a local allocation request associated with a local thread, detect a remove allocation request associated with a remote thread, wherein the remote allocation request bypasses a remote operating system, and process the local allocation request and the remote allocation request with respect to a central heap, wherein the central heap is shared by the local thread and the remote thread.

Example 2 includes the computing system of Example 1, wherein the local allocation request and the remote allocation request include one or more of a first request to allocate a memory block of a specified size, a second request to allocate multiple memory blocks of a same size, a third request to resize a previously allocated memory block, or a fourth request to deallocate the previously allocated memory block.

Example 3 includes the computing system of Example 1, wherein the local allocation request is to be received via an allocator library, and wherein the logic is to write a memory pointer to a completion record that is accessible by the allocator library, and issue an interrupt to the allocator library if the allocator library is operating in a non-polling mode.

Example 4 includes the computing system of Example 1, wherein the remote allocation request is to be received via a network interface card (NIC), and wherein the logic is to update memory bin information, and send a memory buffer pointer to the NIC.

Example 5 includes the computing system of Example 1, wherein the logic is to process the local allocation request with respect to a page heap if the central heap cannot satisfy the local allocation request, process the remote allocation request with respect to the page heap if the central heap cannot satisfy the remote allocation request.

Example 6 includes the computing system of Example 5, wherein the logic is to monitor the page heap for an exhaustion condition, and send an out of band message to a local operating system in response to the exhaustion condition.

Example 7 includes the computing system of any one of Examples 1 to 6, wherein the logic is to prioritize the remote allocation request over the local allocation request.

Example 8 includes the computing system of any one of Examples 1 to 7, wherein the logic is to generate a first profile for the local thread, generate a second profile for the remote thread, and proactively allocate one or more memory bins based on the first profile and the second profile.

Example 9 includes a semiconductor apparatus comprising one or more substrates, and logic coupled to the one or more substrates, wherein the logic is implemented at least partly in one or more of configurable or fixed-functionality hardware, the logic to detect a local allocation request associated with a local thread, detect a remote allocation request associated with a remote thread, wherein the remote allocation request bypasses a remote operating system, and process the local allocation request and the remote allocation request with respect to a central heap, wherein the central heap is shared by the local thread and the remote thread.

Example 10 includes the semiconductor apparatus of Example 9, wherein the local allocation request and the remote allocation request include one or more of a first request to allocate a memory block of a specified size, a second request to allocate multiple memory blocks of a same size, a third request to resize a previously allocated memory block, or a fourth request to deallocate the previously allocated memory block.

Example 11 includes the semiconductor apparatus of Example 9, wherein the local allocation request is to be received via an allocator library, and wherein the logic is to write a memory pointer to a completion record that is accessible by the allocator library, and issue an interrupt to the allocator library if the allocator library is operating in a non-polling mode.

Example 12 includes the semiconductor apparatus of Example 9, wherein the remote allocation request is to be received via a network interface card (NIC), and wherein the logic is to update memory bin information, and send a memory buffer pointer to the NIC.

Example 13 includes the semiconductor apparatus of Example 9, wherein the logic is to process the local allocation request with respect to a page heap if the central heap cannot satisfy the local allocation request, process the remote allocation request with respect to the page heap if the central heap cannot satisfy the remote allocation request.

Example 14 includes the semiconductor apparatus of Example 13, wherein the logic is to monitor the page heap for an exhaustion condition, and send an out of band message to a local operating system in response to the exhaustion condition.

Example 15 includes the semiconductor apparatus of any one of Examples 9 to 14, wherein the logic is to prioritize the remote allocation request over the local allocation request.

Example 16 includes the semiconductor apparatus of any one of Examples 9 to 15, wherein the logic is to generate a first profile for the local thread, generate a second profile for the remote thread, and proactively allocate one or more memory bins based on the first profile and the second profile.

Example 17 includes a method of operating a performance-enhanced computing system, the method comprising detecting, by a memory management subsystem that includes logic coupled to one or more substrates, a local allocation request associated with a local thread, detecting, by the memory management subsystem, a remote allocation request associated with a remote thread, wherein the remote allocation request bypasses a remote operating system, and processing, by the memory management subsystem, the local allocation request and the remote allocation request with respect to a central heap, wherein the central heap is shared by the local thread and the remote thread.

Example 18 includes the method of Example 17, wherein the local allocation request and the remote allocation request include one or more of a first request to allocate a memory block of a specified size, a second request to allocate multiple memory blocks of a same size, a third request to resize a previously allocated memory block, or a fourth request to deallocate the previously allocated memory block.

Example 19 includes the method of any one of Examples 17 to 18, wherein the local allocation request is to be received via an allocator library, and wherein the method further includes writing a memory pointer to a completion record that is accessible by the allocator library, and issuing an interrupt to the allocator library if the allocator library is operating in a non-polling mode.

Example 20 includes the method of any one of Examples 17 to 19, wherein the remote allocation request is to be received via a network interface card (NIC), and wherein the method further comprises updating memory bin information, and sending a memory buffer pointer to the NIC.

Example 21 includes an apparatus comprising means for performing the method of any one of Examples 17 to 20.

Thus, the technology described herein is scalable, even with different entities concurrently performing RDMA operations, with multiple allocations and deallocations to shared memory. The technology addresses the multiple concurrent allocations and deallocations requests to shared memory. Without the technology described herein, a request needs to secure a lock on the shared memory first before allocation. Multiple remote connections contending on locks can result in much more processing overhead. The technology described herein provides a central hardware entity to queue the requests and serve the requests in sequence without individual clients contending for locks.

The technology described herein is also effective in terms of error reporting. For example, the current AiA and data streaming hardware framework provide an exception interrupt mechanism (with indication in the completion record return to the sending entity) that can be used memory management error reporting.

Additionally, the technology described herein is able to handle “memory over subscribe” situations. For example, if “memory over subscribe” refers to more memory being allocated than required, then the LRMM addresses this scenario by conducting periodic memory scans and triggering garbage collection. This solution can be extended to return the extra unneeded memory back to OS. If “memory oversubscribe” refers to more memory being allocated than physically available, this scenario cannot occur as LRMM communicates with the OS for requests and OS would deny the allocation if there is memory exhaustion. This result is another benefit of LRMM communicating with the OS for extra-slow path and not handling the allocation by itself

Embodiments are applicable for use with all types of semiconductor integrated circuit (“IC”) chips. Examples of these IC chips include but are not limited to processors, controllers, chipset components, programmable logic arrays (PLAs), memory chips, network chips, systems on chip (SoCs), SSD/NAND controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the platform within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrases “one or more of A, B or C” may mean A; B; C; A and B; A and C; B and C; or A, B and C.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

We claim:

1. A computing system comprising:
a plurality of processor cores;
a system bus coupled to the plurality of processor cores; and
a memory management subsystem coupled to the system bus, wherein the memory management subsystem includes logic coupled to one or more substrates, the logic to:
detect a local allocation request associated with a local thread,
detect a remote allocation request associated with a remote thread, wherein the remote allocation request bypasses a remote operating system, and
process the local allocation request and the remote allocation request with respect to a central heap, wherein the central heap is shared by the local thread and the remote thread.

2. The computing system of claim 1, wherein the local allocation request and the remote allocation request include one or more of a first request to allocate a memory block of a specified size, a second request to allocate multiple memory blocks of a same size, a third request to resize a previously allocated memory block, or a fourth request to deallocate the previously allocated memory block.

3. The computing system of claim 1, wherein the local allocation request is to be received via an allocator library, and wherein the logic is to:
write a memory pointer to a completion record that is accessible by the allocator library, and
issue an interrupt to the allocator library if the allocator library is operating in a non-polling mode.

4. The computing system of claim 1, wherein the remote allocation request is to be received via a network interface card (NIC), and wherein the logic is to:
update memory bin information, and
send a memory buffer pointer to the NIC.

5. The computing system of claim 1, wherein the logic is to:
process the local allocation request with respect to a page heap if the central heap cannot satisfy the local allocation request,
process the remote allocation request with respect to the page heap if the central heap cannot satisfy the remote allocation request.

6. The computing system of claim 5, wherein the logic is to:
monitor the page heap for an exhaustion condition, and
send an out of band message to a local operating system in response to the exhaustion condition.

7. The computing system of claim 1, wherein the logic is to prioritize the remote allocation request over the local allocation request.

8. The computing system of claim 1, wherein the logic is to:
generate a first profile for the local thread,
generate a second profile for the remote thread, and
proactively allocate one or more memory bins based on the first profile and the second profile.

9. A semiconductor apparatus comprising:
one or more substrates; and
logic coupled to the one or more substrates, wherein the logic is implemented at least partly in one or more of configurable or fixed-functionality hardware, the logic to:
detect a local allocation request associated with a local thread;
detect a remote allocation request associated with a remote thread, wherein the remote allocation request bypasses a remote operating system; and
process the local allocation request and the remote allocation request with respect to a central heap, wherein the central heap is shared by the local thread and the remote thread.

10. The semiconductor apparatus of claim 9, wherein the local allocation request and the remote allocation request include one or more of a first request to allocate a memory block of a specified size, a second request to allocate multiple memory blocks of a same size, a third request to resize a previously allocated memory block, or a fourth request to deallocate the previously allocated memory block.

11. The semiconductor apparatus of claim 9, wherein the local allocation request is to be received via an allocator library, and wherein the logic is to:
write a memory pointer to a completion record that is accessible by the allocator library; and
issue an interrupt to the allocator library if the allocator library is operating in a non-polling mode.

12. The semiconductor apparatus of claim 9, wherein the remote allocation request is to be received via a network interface card (NIC), and wherein the logic is to:
update memory bin information; and
send a memory buffer pointer to the NIC.

13. The semiconductor apparatus of claim 9, wherein the logic is to:
process the local allocation request with respect to a page heap if the central heap cannot satisfy the local allocation request;
process the remote allocation request with respect to the page heap if the central heap cannot satisfy the remote allocation request.

14. The semiconductor apparatus of claim 13, wherein the logic is to:
monitor the page heap for an exhaustion condition; and
send an out of band message to a local operating system in response to the exhaustion condition.

15. The semiconductor apparatus of claim 9, wherein the logic is to prioritize the remote allocation request over the local allocation request.

16. The semiconductor apparatus of claim 9, wherein the logic is to:
generate a first profile for the local thread;
generate a second profile for the remote thread; and
proactively allocate one or more memory bins based on the first profile and the second profile.

17. A method comprising:
detecting, by a memory management subsystem that includes logic coupled to one or more substrates, a local allocation request associated with a local thread;
detecting, by the memory management subsystem, a remote allocation request associated with a remote thread, wherein the remote allocation request bypasses a remote operating system; and
processing, by the memory management subsystem, the local allocation request and the remote allocation request with respect to a central heap, wherein the central heap is shared by the local thread and the remote thread.

18. The method of claim 17, wherein the local allocation request and the remote allocation request include one or more of a first request to allocate a memory block of a specified size, a second request to allocate multiple memory blocks of a same size, a third request to resize a previously allocated memory block, or a fourth request to deallocate the previously allocated memory block.

19. The method of claim 17, wherein the local allocation request is to be received via an allocator library, and wherein the method further includes:
writing a memory pointer to a completion record that is accessible by the allocator library, and
issuing an interrupt to the allocator library if the allocator library is operating in a non-polling mode.

20. The method of claim 17, wherein the remote allocation request is to be received via a network interface card (NIC), and wherein the method further comprises:
updating memory bin information, and
sending a memory buffer pointer to the NIC.
